(19) United States
(12) Patent Application Publication
(10) Pub. No.: US 2006/0292913 A1
(43) Pub. Date: Dec. 28, 2006

(54) Integrated direct fuel pump connector

(75) Inventor: Jeffery John Milton, Lake Orion, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/451,493

(22) Filed: Jun. 13, 2006

Related U.S. Application Data
(60) Provisional application No. 60/693,160, filed on Jun. 23, 2005.

(51) Int. Cl. H01R 13/52

(52) U.S. Cl. 439/271

(57) ABSTRACT

A header 10 is provided for connecting a fuel tank flange 16 to a fuel pump 24. The header 10 includes a body 12 constructed and arranged to be coupled to the fuel tank flange in a sealed manner. Terminal structure 26 extends through the body and has a first end 28 constructed and arranged to provide an electrical connection outside of the fuel tank flange, and a second end 30 constructed and arranged to electrically connect directly with an associated terminal 32 of the fuel pump.

This application claims the benefit of the earlier filing date of U.S. Provisional Application No. 60/693,160, filed on Jun. 23, 2005, which is incorporated by reference herein in its entirety.

### FIELD OF THE INVENTION

This invention relates to automotive fuel systems and, more particularly, to a method of connecting a fuel pump directly to a fuel tank flange.

### BACKGROUND OF THE INVENTION

Conventional fuel delivery systems include a header that connects to a fuel tank flange. A fuel pump is provided in the fuel tank. To provide electrical connection to the fuel pump that is accessible outside of the fuel tank, typically, the header includes power wires that are accessible outside of the fuel tank. First ends of pump wires are electrically connected to the power wires via a first connector disposed inside of the fuel tank. Second ends of the pump wires are electrically connected to the fuel pump by a second connector. The power wires electrically connect to a power source, outside of the fuel tank flange, to power the fuel pump. Alternatively, the pump wires can be part of the header and extend through the header so that there is no need for the first connector. However, the pump wires and connectors add components and cost to the overall system.

Thus, there is a need to provide a direct connection of a fuel pump to a fuel tank flange that does not require wires or connectors for electrical connection to a fuel pump.

### SUMMARY OF THE INVENTION

An object of the invention is to fulfill the need referred to above. In accordance with the principles of the present invention, this objective is achieved by providing a header for connecting a fuel tank flange to a fuel pump. The header includes a body constructed and arranged to be coupled to the fuel tank flange in a sealed manner. Terminal structure, extending through the body, has a first end constructed and arranged to provide an electrical connection outside of the fuel tank flange, and a second end constructed and arranged to electrically connect directly with an associated terminal of the fuel pump.

In accordance with another aspect of the invention, a connector assembly includes a fuel tank having a flange with an opening therein, a fuel pump disposed in the fuel tank and having pump terminals, and a header. The header includes a body disposed in the opening and coupled to the fuel tank flange in a sealed manner, and header terminal structures extending through the body. Each header terminal structures has a first end constructed and arranged to provide an electrical connection outside of the fuel tank flange, and a second end electrically connected directly with an associated pump terminal.

In accordance with yet another aspect of the invention, a method of connecting a fuel tank flange to a fuel pump disposed in the fuel tank provides a fuel tank having an opening in a flange thereof. A fuel pump is provided in the fuel tank. The fuel pump has pump terminals. A header is provided that has a body and header terminal structures extending through the body. Each header terminal structure has a first and second ends. The body is mounted in the opening in a sealed manner. The second ends of the header terminal structures are electrically connected to associated pump terminals, with the first ends of the header terminal structures being accessible outside of the fuel tank.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawing, in which:

FIG. 1 is a schematic view of a header, in accordance with the principles of the invention, having a terminal structure in the form of a terminal that is shown electrically connected directly with a terminal of a fuel pump.

FIG. 2 is a schematic view of a header, in accordance with another embodiment of the invention, having terminal structure in the form of a wire and a terminal that is shown electrically connected directly with a terminal of a fuel pump.

FIG. 3 is an enlarged sectional view of isolating structure provided between a header connector and a fuel pump connector to reduce noise.

### DETAILED DESCRIPTION OF THE EXEMPLARY EMBODIMENTS

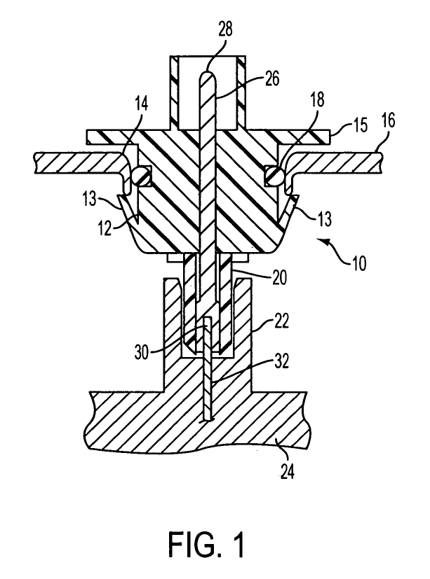

With reference to FIG. 1, a header or connector, generally indicated at 10, is shown in accordance with the principles of the invention. The header 10 is part of a connector assembly that also includes a fuel tank having a flange 16 and a fuel pump 24 disposed in the fuel tank. Thus, the header 10 is connected to terminals of the conventional fuel pump 24 of a vehicle and is mounted in an opening 14 defined in the fuel tank flange 16. The header 10 has a body 12, preferably of molded plastic. An O-ring 18 is provided about the periphery of the body 12 to provide a seal between the tank 16 and header 10. The body 12 include spring tabs 13 such that when biased, the tabs 13 permit the header 10 to be moved through the opening 14, and when unbiased or relaxed, the tabs 13 flare outwardly and engage the tank 16, preventing movement of the header 10 back through the opening 14. A header flange 15 can rest on the flange tank flange 16.

A header connector 20 extends from the body 12 and is constructed and arranged to be received in a pump connector 22 that extends from a top of the fuel pump 24 and substantially surrounds the pump terminals 32. Only a portion of the fuel pump 24 is shown. The header connector 20 is preferably integral with the header 10, but the connector 20 can be a separate element that is coupled with the header 10. The header connector 20 substantially surrounds the second end 30 the terminals.

The header 10 includes header terminal structure. In the embodiment of FIG. 1, the terminal structure includes terminals 26 are preferably molded into the body 12 such that at least a portion of each terminal is encapsulated by the plastic material and thus sealed with respect to the body 12. One terminal 26 is shown FIG. 1, but a plurality of terminals 28 can be provided as needed to operate the fuel pump 24. Additionally, terminals 26 can be provided for other use with other components as needed such as, for example, to operate level sensor (not shown). Instead of molding the terminals into the body 12, the terminals 26 can be pressed into the header 10 and sealed or the terminals 26 can be over-molded in a single or multiple piece configuration.

Each terminal 26 has a first end 28 and a second end 30. The first end 28 is constructed and arranged to provide an electrical connection outside of the tank flange 16, such as with a power source (not shown) for powering the fuel pump 24. The second end 30 preferably defines a female connector for receiving a pump terminal 32 extending from the fuel pump 24. Thus, when the header connector 20 is received in the fuel pump connector 22, a fuel pump terminal 32 directly engages an end 30 of an associated terminal 26 of the header 10 so that the fuel pump 24 is electrically coupled to the header 10 and directly mechanically coupled to the flange 16. Thus, no wires or connectors are required since the terminals make the electrical connections directly.

In the embodiment of FIG. 1, end 30 of the terminal 26 is a female connection receiving the male terminal 32. It can be appreciated that the terminal 32 of the pump can define the female connector with the end 30 of terminal 26 of the header 10 being male. With reference to FIG. 3, it can be appreciated that the instead of providing the female connector integrally with the terminal 26, end 30 of the terminal 26 can be configured such that the female connector 38 is a separate part that snaps into or is otherwise electrically connected with the terminal 26.

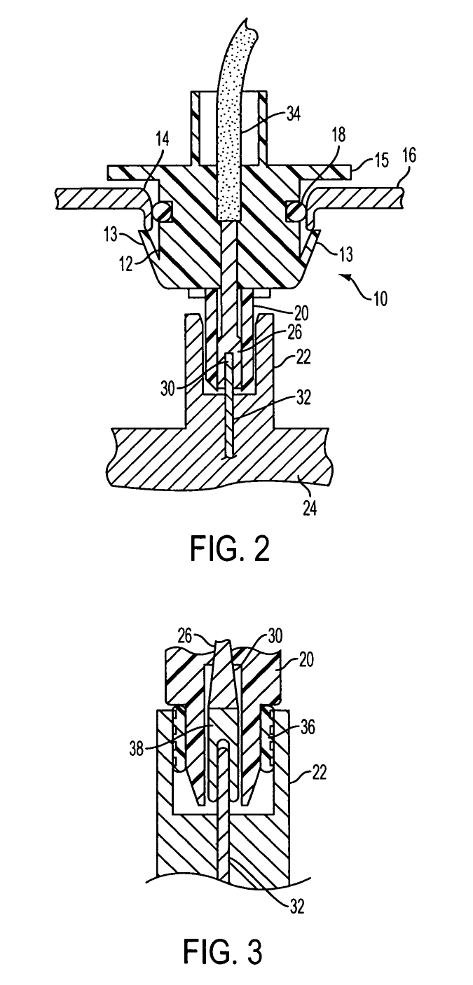

With reference to FIG. 2, in accordance with another embodiment of the invention, each or certain of the header terminal structures of the header 10 includes a terminal 26 and a wire 34 electrically connected to the terminal 26. Thus, the terminal 26 extends into the body 12 and is electrically connected with terminal 30 of the fuel pump 24, and the wire 34 extends from the header 10 so as to be accessible outside of the fuel tank. Thus, no wires or connectors are required for connection to the fuel pump, since the header terminal structures make the electrical connections directly.

The header 10 provides crash protection by de-coupling the fuel pump from the exterior of the flange 16. In the event of a vehicle crash, there would not be a leak path created if the pump were to be disconnected from the header 10. In addition, the header 10 provides noise reduction by de-coupling the pump from the exterior of the flange 16 and using an isolating structure or grommet 36 in the header 10 (FIG. 3). The use of isolating structure or grommet 36, for example, between a wall of the fuel pump connector 22 and pump connector 20, reduces noise and vibration transmission to the flange 16, other components and to the environment. The grommet 36 also provides a sealed area of the connection for use in flexible fuel environments with high alcohol content which is helpful due to the conductivity of alcohol containing fuels.

Although an O-ring 18 is shown about the periphery of the body 12 as a seal member to provide the seal between the tank 16 and header 10, other sealing methods can be used such as, a lip seal, a press-fit plastic bead molded into the header 10, over-molding, epoxy/potting of the header 10 to flange 16.

Instead of using the spring tabs 13 to connect the header 10 to the flange 16, other connection methods such as those listed below can be employed:
cam lock into the flange 16
crimp fitting
screw-in
snap-fit with beads
‘fir-tree’ type press-in connection
over-mold the header 10 on the flange 16
press-fit the header 10 with no rubber seal
use a ‘star washer’ to hold the header 10 in place
heat stake the header 10 to the flange 16
laser/vibration/ultrasonic welding
plastic-metal sandwich weld of the header 10
bent metal tabs to hold header 10 in place
header flange 15 on inside of tank flange 16

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A header for connecting a fuel tank flange to a fuel pump, the header comprising:
a body constructed and arranged to be coupled to the fuel tank flange in a sealed manner, and
terminal structure extending through the body, the terminal structure having a first end constructed and arranged to provide an electrical connection outside of the fuel tank flange, and a second end constructed and arranged to electrically connect directly with an associated terminal of the fuel pump.

2. The header of claim 1, wherein the body is composed of plastic material and the terminal structure includes terminals molded together with the body such that a portion of the each terminal is encapsulated by the plastic material.

3. The header of claim 1, when the terminals structure includes terminals that are pressed into the body.

4. The header of claim 1, wherein the terminal structure includes a terminal and a wire electrically coupled to the terminal, the wire defining the first and the terminal defining the second end.

5. The header of claim 1, wherein the second end of the terminal structure includes a female connector.

6. The header of claim 1, wherein the body includes spring tabs constructed and arranged when biased to permit insertion of the body through an opening in the flange and, in an unbiased condition, to engage the flange to prevent movement of the body back through the opening in the flange.

7. The header of claim 1, wherein a header connector extends from the body, the header connector substantially surrounds the second end of the terminal structure and is constructed and arranged to be received by a pump connector of the fuel pump.

8. The header of claim 7, wherein the header connector is integral with the body.

9. The header of claim 1, further including a seal member disposed about the periphery of the body and constructed and arranged to seal the header with respect to the flange.

10. The header of claim 7, further comprising isolating structure about a portion of the header connector constructed and arranged to isolate noise when the header connector is received by the pump connector.

11. A connector assembly comprising:
a fuel tank having a flange, the flange having an opening therein,
a fuel pump disposed in the fuel tank and having pump terminals, and
a header comprising:
a body disposed in the opening and coupled to the fuel tank flange in a sealed manner, and
header terminal structures extending through the body, each header terminal structure having a first end constructed and arranged to provide an electrical connection outside of the fuel tank flange, and a second end electrically connected directly with an associated pump terminal.

12. The assembly of claim 11, wherein the body is composed of plastic material and each header terminal structure includes a header terminal molded together with the body such that a portion of the each header terminal is encapsulated by the plastic material.

13. The assembly of claim 11, when each header terminal structure includes a header terminal pressed into the body.

14. The assembly of claim 11, wherein a header terminal structure includes a terminal and a wire electrically coupled to the terminal, the wire defining the first and the terminal defining the second end.

15. The assembly of claim 11, wherein the second end of each header terminal structure includes a female connector and the pump terminals have mating male ends.

16. The assembly of claim 11, wherein the body includes spring tabs constructed and arranged when biased to permit insertion of the body through the opening, in an unbiased condition, the tabs engage the flange to prevent movement of the body back through the opening.

17. The assembly of claim 11, wherein a header connector extends from the body, the header connector substantially surrounds the second end of the header terminal structures, and wherein the fuel pump has a pump connector substantially surrounding the pump terminals, the header connector being received in the fuel pump connector.

18. The assembly of claim 17, further comprising isolating structure between a portion of the header connector and a portion of the pump connector to isolate noise.

19. The assembly of claim 17, wherein the header connector is integral with the body.

20. The assembly of claim 11, further including a seal member disposed about the periphery of the body to seal an opening between the body and the flange.

21. A method of connecting a fuel tank flange to a fuel pump disposed in the tank, the method including:
providing a fuel tank having an opening in a flange thereof,
providing a fuel pump in the fuel tank, the fuel pump having pump terminals,
providing a header having a body and header terminal structures extending through the body, each header terminal structures having a first and second ends,
mounting the body in the opening in a sealed manner, and
electrically connecting the second ends of the header terminal structures to associated pump terminals, with the first ends of the header terminal structures being accessible outside of the fuel tank.

22. The method of claim 21, wherein a header connector extends from the body, the header connector substantially surrounds the second end of the header terminal structures, and wherein the fuel pump has a pump connector substantially surrounding the pump terminals, the method including receiving the header connector in the pump connector when electrically connecting the header terminal structures to the pump terminals.

23. The method of claim 21, wherein the mounting step includes providing a seal member about the periphery of the body to seal an opening between the body and the flange.

24. The method of claim 21, wherein the step of electrically connecting includes providing the second end of each header terminal structure as a female connector and providing each pump terminal as a mating male connector.
